(19) United States
(12) Patent Application Publication
(10) Pub. No.: US 2026/0349205 A1
(43) Pub. Date: Nov. 5, 2026

(54) Photonic Multi-Chip Assembly

(71) Applicant: University of Rochester, Rochester, NY (US)

(72) Inventors: Jaime Cardenas Gonzalez, Rochester, NY (US); Supun Liyanaarachchi, Rochester, NY (US); Tengqian Wang, Rochester, NY (US)

(21) Appl. No.: 19/665,643

(22) Filed: May 1, 2026

Related U.S. Application Data
(60) Provisional application No. 63/799,001, filed on May 2, 2025.

(51) Int. Cl. G02B 6/43; G02B 6/42

(52) U.S. Cl. CPC G02B 6/43; G02B 6/423; G02B 6/4262

(57) ABSTRACT

A multi-chip assembly, comprising a first and a second photonic chip, each photonic chip comprising one or more layers forming a body having at least a first side and a second side, wherein the first side comprises a first connection interface comprising at least one protrusion and the second side comprises a second connection interface comprising at least one divot, and wherein the first and second connection interfaces of the first and second photonic chips respectively, are configured to couple in an interlocking manner. Also described herein is a modular photonic chip packaging system, comprising a substrate having at least one elongated channel, at least one photonic chip positioned on the substrate, the at least one photonic chip having a bottom surface and at least one elongated protrusion on the bottom surface, wherein the at least one elongated protrusion is shaped to fit within the at least one elongated channel.

### CROSS-REFERENCE TO RELATED APPLICATIONS

This application claims priority to U.S. Provisional Application No. 63/799,001 filed on May 2, 2025, the contents of which are incorporated by reference herein in their entirety.

### STATEMENT REGARDING FEDERALLY SPONSORED RESEARCH OR DEVELOPMENT

This invention was made with government support under N6893624C0020 awarded by the Air Force Research Laboratory. The government has certain rights in the invention.

### BACKGROUND

Integrated photonics is a rapidly advancing field where optical components and circuits are fabricated on a single chip to enable high-speed data transmission, sensing, and signal processing with minimal footprint. As the complexity of photonic devices has increased, there has emerged a need for efficient packaging solutions that allow direct chip-to-chip optical connections while maintaining precise alignment and low loss. Traditionally, photonic chips are packaged individually and connected through optical fibers, free-space coupling, or butt-coupling methods, which may require bulky fixtures and suffer from alignment challenges, increased insertion loss, and scalability limitations when interconnecting multiple chips. Some approaches employ flip-chip bonding or use micro-optics for alignment; however, these can be cost-prohibitive and complicated, particularly for large-scale integration or modular assembly.

Current photonic systems predominantly utilize optical fibers to connect photonic integrated circuits (PICs) with other chips or external modules. While this method effectively supports long-distance data transmission, it becomes less efficient and overly cumbersome for short-range, chip-to-chip communication within a package or on a printed circuit board (PCB). In systems comprising multiple chips, each requiring optical input/output (I/O), the proliferation of necessary fibers not only increases the system's footprint but also complicates fiber alignment, packaging, and thermal management. Issues such as fiber crowding and limitations on bend radii can detrimentally impact both performance and reliability. Additionally, the coupling of fibers to chips often relies on extra components like grating couplers or edge couplers, which may introduce optical losses and heighten sensitivity to alignment.

Thus, there is a need in the art for novel photonics packaging architectures that facilitate efficient, compact, and modular chip-to-chip connections while simplifying assembly and alignment processes for multi-chip photonic systems.

### SUMMARY

A multi-chip assembly, comprising a first and a second photonic chip, each photonic chip comprising one or more layers forming a body having at least a first side and a second side, wherein the first side comprises a first connection interface comprising at least one protrusion and the second side comprises a second connection interface comprising at least one divot, and wherein the first and second connection interfaces of the first and second photonic chips respectively, are configured to couple in an interlocking manner.

In some embodiments, the at least one protrusion and the at least one divot have complementary geometries. In some embodiments, the at least one protrusion and the at least one divot have a square shape, a rectangular shape, a circular shape, an ovular shape, an arc shape, an irregular shape, or any combinations thereof. In some embodiments, the at least one protrusion and the at least one divot are formed in at least one layer of the one or more layers. In some embodiments, the first side and the second side are opposing sides. In some embodiments, the first side and the second side are adjacent sides.

In some embodiments, the one or more layers comprise a top layer, a middle layer, and a bottom layer. In some embodiments, the one or more layers comprise a material selected from the group consisting of: silicon dioxide, silicon nitride, silicon oxynitride, germanium, silicon germanium, lithium niobate, aluminum nitride, barium titanate, strontium titanate, aluminum gallium arsenide, gallium nitride, indium arsenide, sapphire, and diamond. In some embodiments, the first photonic chip and the second photonic chip are oriented perpendicularly to each other. In some embodiments, the first and second photonic chips further comprise a waveguide integrated into at least one layer of the one or more layers and extending between the first and second connection interfaces of each photonic chip, wherein the coupling of the first and second connection interfaces of the first and second photonic chips causes the waveguides to be optically aligned.

Aspects of the present disclosure relate to a modular photonic chip packaging system, comprising a substrate having at least one elongated channel, at least one photonic chip positioned on the substrate, the at least one photonic chip having a bottom surface and at least one elongated protrusion on the bottom surface, wherein the at least one elongated protrusion is shaped to fit within the at least one elongated channel.

In some embodiments, the at least one elongate channel comprises a bottom channel portion having a first width and a top channel portion having a second width. In some embodiments, the at least one elongated protrusion comprises a first portion having a width equal to the first width of the elongated channel and a second portion having a width equal to the second width of the elongated channel. In some embodiments, the system further comprises at least two photonic chips arranged along the elongated channel, such that the at least two photonic chips are optically coupled. In some embodiments, the system further comprises a plurality of photonic chips arranged along the elongated channel, such that the plurality of photonic chips are optically coupled. In some embodiments, the system further comprises a plurality of elongated channels, and a plurality of photonic chips arranged along each channel, such that the plurality of photonic chips along each channel are optically coupled.

In some embodiments, the substrate comprises a top surface and a bottom surface, wherein the top surface and the bottom surface each comprise at least one elongated channel. In some embodiments, a plurality of photonic chips are positioned along each elongated channel on the top and bottom surfaces of the substrate. In some embodiments, the system further comprises a first substrate and a second substrate fixedly attached to each other. In some embodiments, the first and second substrates are oriented perpendicularly to each other.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1 is a schematic of two exemplary photonic chips.

FIG. 2 is a schematic of an exemplary photonic chip.

FIG. 3 is a top-view of exemplary photonic chips connected to each other.

FIG. 4 is a schematic of an exemplary photonic chip.

FIG. 5 is a top-view of exemplary photonic chips connected to each other.

FIG. 6 is a schematic of an exemplary photonic chip.

FIG. 7 is a schematic of an exemplary photonic chip.

FIG. 8 is a schematic showing exemplary vertical coupling of the photonic chips.

FIG. 9 is a schematic of an exemplary photonic chip packaging system.

FIG. 10 is a schematic of an exemplary substrate.

FIG. 11 is a schematic of an exemplary photonic chip.

FIG. 12 is a schematic of exemplary photonic chips connected to each other on the substrate.

FIG. 13 is a schematic of an exemplary reconfigurable and three-dimensional photonic architecture.

FIG. 14 is a schematic of an exemplary reconfigurable and three-dimensional photonic architecture.

FIG. 15 depicts an illustrative computer architecture for a computer for practicing the various embodiments of the invention.

### DETAILED DESCRIPTION

The following discussion omits or only briefly describes conventional features of integrated photonics devices and/or systems that are apparent to those skilled in the art. Those of ordinary skill in the pertinent arts may thus recognize that other elements may be desirable and/or necessary to implement the devices, systems, and/or methods described herein. It is noted that various embodiments are described in detail with reference to the drawings. Reference to these various embodiments does not limit the scope of the claims attached hereto. Additionally, any embodiments set forth in this specification are intended to be non-limiting and merely set forth some of the many possible implementations for the appended claims. Further, particular features described herein can be used in combination with other described features in each of the various possible combinations and permutations. As such, it is understood that this detailed description is exemplary and explanatory only and is not restrictive of the broad inventive concepts upon which the embodiments disclosed herein are based.

Unless otherwise specifically defined herein, all terms are to be given their broadest reasonable interpretation. This includes meanings implied from the specification as well as meanings understood by those skilled in the art and/or as defined in dictionaries, treatises, etc.

It is noted that, as used in this specification and the appended claims, the singular forms “a,” “an,” and “the” include plural referents unless otherwise specified. The term “includes” and/or “including,” when used in this specification, specify the presence of stated features, elements, and/or components, but do not preclude the presence or addition of one or more other features, steps, operations, elements, components, and/or groups thereof.

Relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then-described or as shown in the drawing figure under discussion. These relative terms are for convenience of description and normally are not intended to require a particular orientation in actuality. Terms including “inwardly” versus “outwardly,” “longitudinal” versus “lateral,” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The phrases “operatively” or “operably connected” indicates such an attachment, coupling, or connection that allows the pertinent structures to operate as intended by virtue of that relationship.

Reference throughout the specification to “one embodiment,” “an embodiment,” or “some embodiments” means that a particular feature, structure, or characteristic described in connection with at least one embodiment of the subject matter is included in at least one embodiment of the subject matter disclosed. Thus, the appearance of the phrases “in one embodiment,” “in an embodiment,” or “in some embodiments” in various places throughout the specification is not necessarily referring to the same embodiment. Further, the particular features, structures, or characteristics of “one embodiment,” “an embodiment,” or “some embodiments” may be combined in any suitable manner with each other to form additional embodiments of such combinations. It is intended that embodiments of the disclosed subject matter cover modifications and variations thereof. Terms such as “first,” “second,” “third,” etc., merely identify one of a number of portions, components, steps, operations, functions, and/or points of reference as disclosed herein, and likewise to not necessarily limit embodiments of the present disclosure to any particular configuration or orientation.

Moreover, throughout this disclosure, various aspects can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments therebetween. This applies regardless of the breadth of the range. As used herein, the term “about” in reference to a measurable value, such as an amount, a temporal duration, and the like, is meant to encompass the specified value or variations of plus or minus 20%, plus or minus 10%, plus or minus 5%, plus or minus 1%, and plus or minus 0.1% of the specified value, as such variations are appropriate and fit within the confines of a functional system.

The terms “proximal,” “distal,” “anterior,” “posterior,” “medial,” “lateral,” “superior,” and “inferior” are defined by their standard usage indicating a directional term of reference. For example, “proximal” refers to a position that is situated nearer to the center of a body or point of attachment or interest. In another example, “anterior” refers to the front of a body or structure, while “posterior” refers to the rear of a body or structure, in relation to a relative viewpoint. In another example, “medial” refers to the direction towards the midline of a body or structure, and “lateral” refers to the direction away from the midline of a body or structure. In some examples, “lateral” or “laterally” may refer to any sideways direction. In another example, “superior” refers to the top of a body or structure, while “inferior” refers to the bottom of a body or structure. It should be understood, however, that the directional term of reference may be interpreted within the context of a specific body or structure, such that a directional term referring to a location in the context of the reference body or structure may remain consistent as the orientation of the body or structure changes.

Aspects of the present disclosure relate to a multi-photonic chip assembly having an interconnection system for photonic modules which implements a novel interlocking waveguide design. The disclosed assembly minimizes dependency on traditional fiber optics, facilitating direct optical coupling between integrated modules. By doing so, it enhances efficiency and performance in short-range communication, addressing the limitations associated with existing fiber-based solutions.

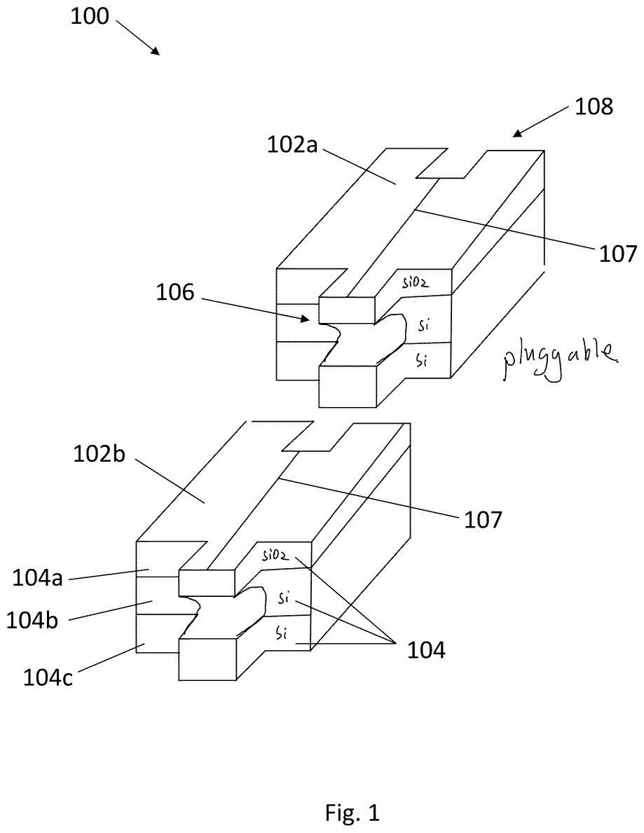

Referring now to FIG. 1, shown is an exemplary multi-chip assembly 100. The multi-chip assembly 100 generally includes at least one photonic chip 102 (for example, a first photonic chip 102a and a second photonic chip 102b). The photonic chip 102 comprises one or more layers 104 forming a body. For example, the photonic chip 10b comprises a top layer 104a, a middle layer 104b, and a bottom layer 104c. In other examples, the photonic chip 102 may comprise any number of layers. In some embodiments, at least one layer of the one or more layers 104 comprises at least one waveguide 107. The waveguide 107 may be positioned in the top layer 104a, the middle layer 104b, or the bottom layer 104c. In some embodiments, at least the top layer 104a may comprise silicon dioxide (SiO₂). In some embodiments, at least the middle layer 104b and the bottom layer 104c may comprise silicon (Si). In some embodiments, the one or more layers 104 may comprise materials including, but not limited to, silicon dioxide, silicon nitride, silicon oxynitride, germanium, silicon germanium, lithium niobate, aluminum nitride, barium titanate, strontium titanate, aluminum gallium arsenide, gallium nitride, indium arsenide, sapphire, diamond, or any combinations thereof.

In some embodiments, the photonic chip 102 comprises a first side forming a first connection interface 106 and a second side forming a second connection interface 108. In some embodiments, the first connection interface 106 and the second connection interface 108 are generally shaped to mate with each other in an interlocking configuration, such that a first photonic chip 102a and a second photonic chip 102b may be connected via their respective first and second interfaces 106 and 108. In some embodiments, the waveguide 107 extends between the first connection interface 106 and the second connection interface 108. In some embodiments, the connection between the first photonic chip 102a and the second photonic chip 102b causes the waveguides 107 of each photonic chip to be optically aligned. In some embodiments, the first and second connection interfaces 106 and 108 may be formed in any two sides of the photonic chip 102. For example, the first and second connection interfaces may be formed on opposing sides or on adjacent sides of the photonic chip 102. In some embodiments, the multi-chip assembly 100 may comprise a plurality of photonic chips 102 connected to each other via their first and second connection interfaces. In some embodiments, the photonic chips 102 may comprise metal pads that are optically aligned via the connection of the first and second connection interfaces. In some embodiments, the photonic chips 102 may be electronic chips, or any other chip or structure that needs to be aligned.

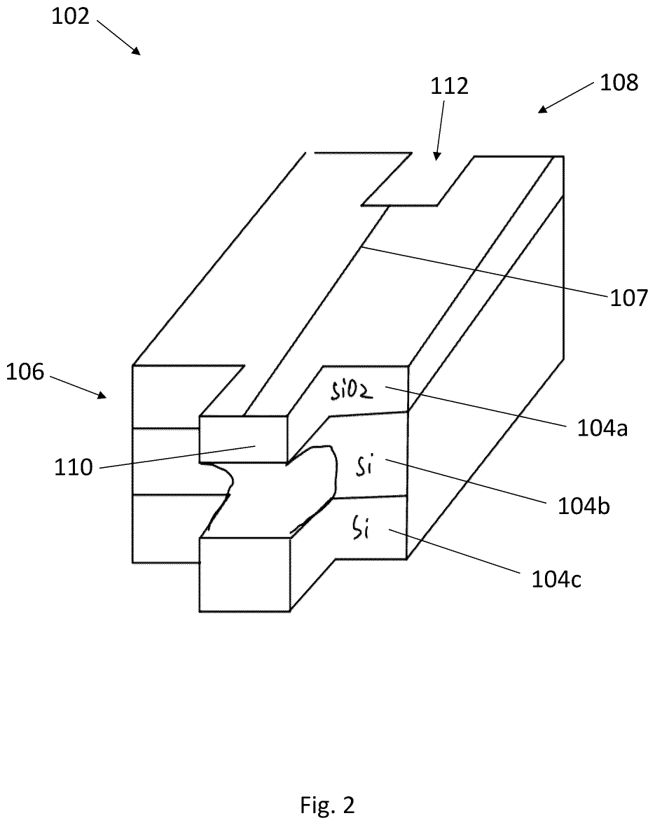

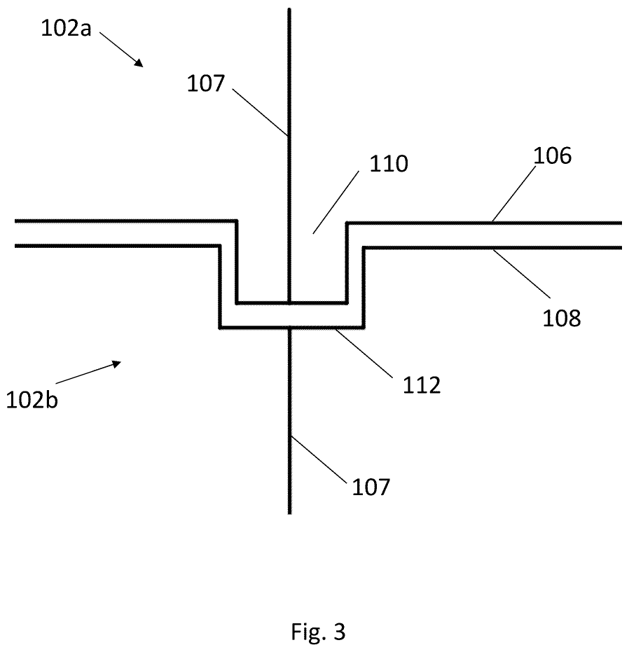

Referring now to FIG. 2, the first connection interface 106 may comprise at least one protrusion 110. The protrusions 110 may be formed from an extension of at least one of the layers 104. In some embodiments, the protrusion 110 may be formed only in the top layer 104a, only in the middle layer 104b, or only the bottom layer 104c. In some embodiments, the protrusion 110 may be formed in at least two of the top layer 104a, the middle layer 104b, or the bottom layer 104c. In some embodiments, the protrusion 110 may be formed in all three layers 104. In some embodiments, the protrusion 110 may have any shape or geometry. For example, the protrusion 110 may have a cuboidal shape, a square shape, a semi-circle shape, an arc shape, a curved shape, an irregular shape, or any combinations thereof. The second connection interface 108 may comprise a divot 112. The divot 112 is shaped to have a complementary geometry to that of the protrusion 110 such that the divot 112 mates with the protrusion 110 in an interlocking configuration. For example, the divot 112 may have a cuboidal shape, a square shape, a semi-circle shape, an arc shape, a curved shape, an irregular shape, or any combinations thereof. FIG. 3 depicts a top view of the interlocking configuration.

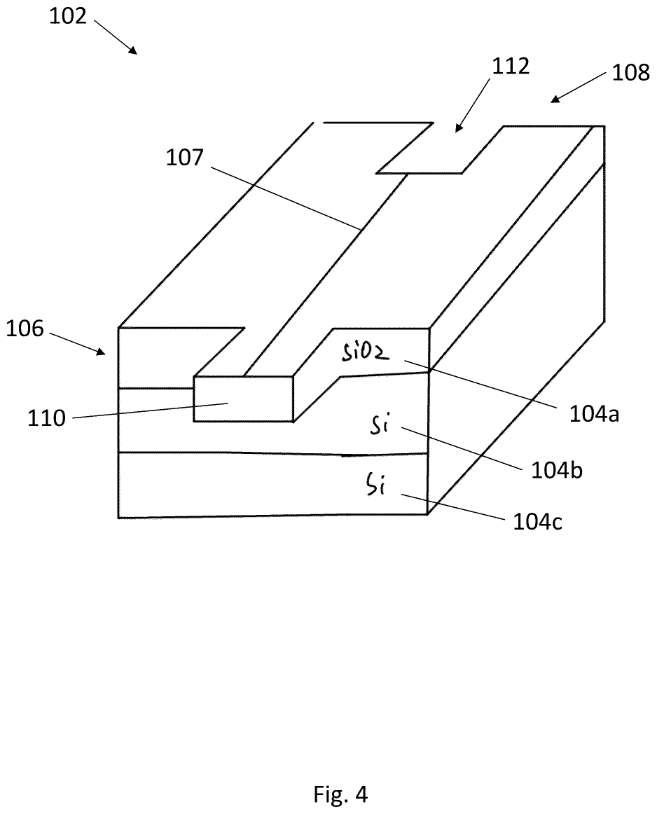

Referring now to FIG. 4, shown is an exemplary configuration for the first and second connection interfaces 106 and 108 of a photonic chip 102. The first connection interface 106 comprises a square-shaped protrusion 110 formed only in the top layer 104a of the photonic chip 102. The second connection interface 108 comprises a square-shaped divot 112 formed only in the top layer 104a of the photonic chip 102.

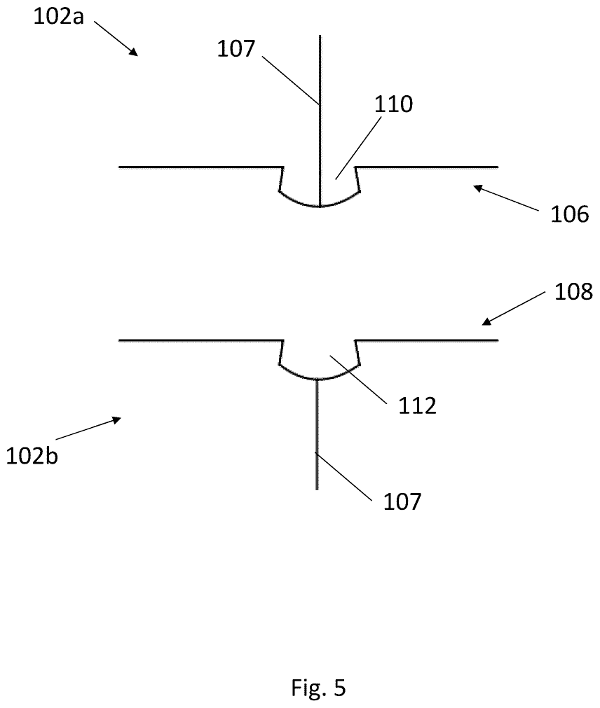

Referring now to FIG. 5, shown is a top view of an exemplary configuration for the first and second connection interfaces 106 and 108 of first and second photonic chips 102a and 102b, respectively. The first connection interface 106 comprises an arc-shaped protrusion 110 in the first photonic chip 102a and the second connection interface 108 comprises a corresponding arc-shaped divot 112 in the second photonic chip 102b.

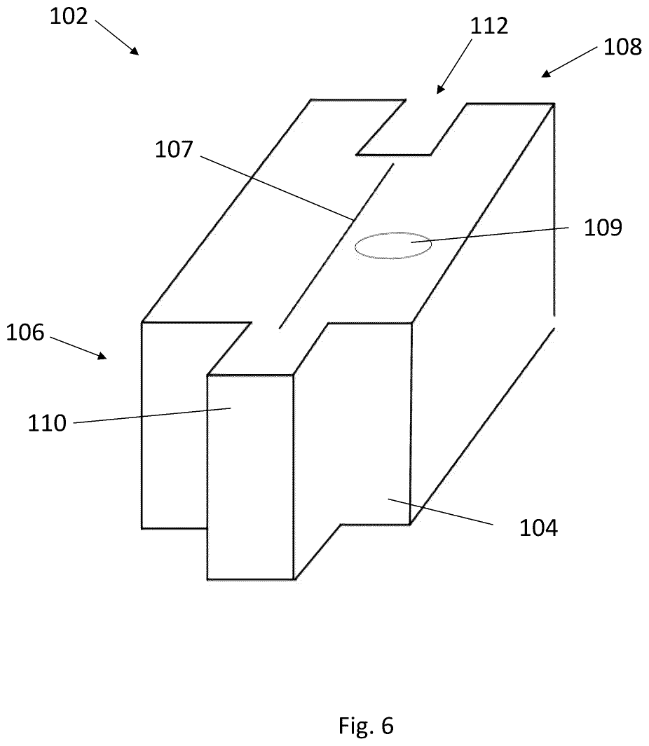

Referring now to FIG. 6, shown is an exemplary configuration for the first and second connection interfaces 106 and 108 of a photonic chip 102. The first connection interface 106 comprises a cuboidal protrusion 110 formed in all layers 104 of the photonic chip 102. The second connection interface 108 comprises a cuboidal divot 112 formed in all layers 104 of the photonic chip 102. In some embodiments, the photonic chip 102 may comprise a ring resonator 109.

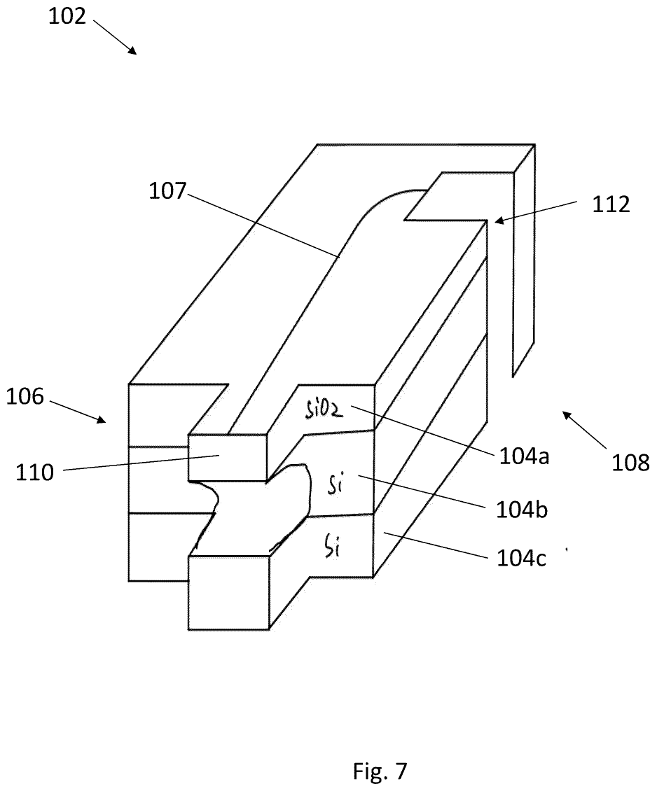

Referring now to FIG. 7, shown is an exemplary configuration for the first and second connection interfaces 106 and 108 of a photonic chip 102. The first connection interface 106 comprises an irregularly shaped protrusion 110 formed in all layers 104 of the photonic chip 102. The second connection interface 108 comprises a corresponding irregularly shaped divot 112 formed in all layers 104 of the photonic chip 102. The second connection interface 108 is formed in an adjacent side to the first connection interface 106, such that the waveguide 107 is curved to extend between the protrusion 110 and the divot 112.

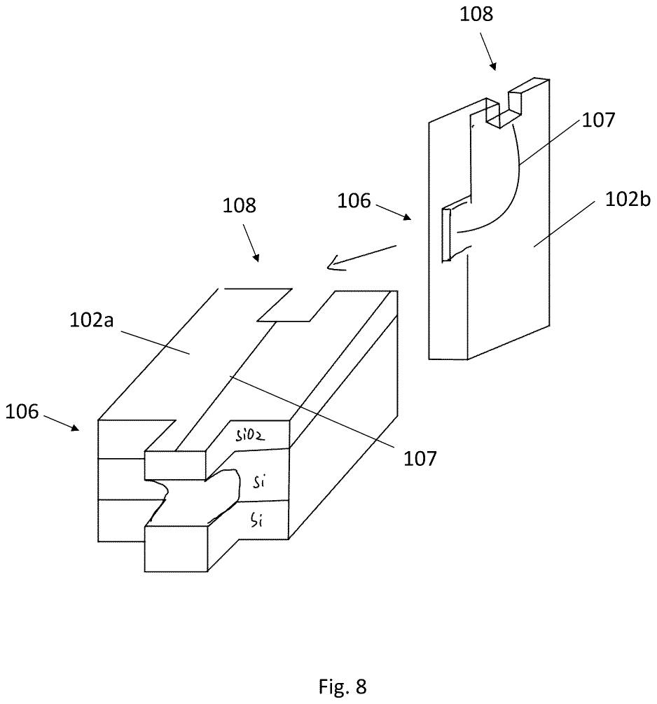

Referring now to FIG. 8, the first and second photonic chips 102a and 102b may be oriented perpendicularly to each other. For example, the first photonic chip 102a may be positioned in a horizonal orientation, while the second photonic chip 102b may be positioned in a vertical orientation. In such cases, the waveguide 107 of the second photonic chip 102b may comprise a curved portion such that a first end of the waveguide of the second photonic chip 102b aligns with the waveguide of the first photonic chip 102a, while a second end of the waveguide 107 is angled at about 90 degrees relative to the first end. In some embodiments, the multi-chip assembly 100 comprises a plurality of interconnected photonic chips 102, wherein the photonic chips 102 may be oriented horizontally or vertically.

In some embodiments, and when the photonic chips 102 are assembled, the inherent mechanical forces create a secure interlock that prevents movement. This interlocking mechanism not only enhances stability but also ensures a reliable packaging configuration that resists displacement during operation, ultimately contributing to improved performance and durability.

The multi-chip assembly 100 minimizes the air gap between the waveguides, significantly reducing Fresnel Reflection at the interfaces. This configuration leads to a decrease in overall signal loss. Additionally, if the waveguides possess identical guiding structures, this further minimizes loss by maximizing the overlap of propagation modes. Consequently, a greater proportion of power is effectively coupled into the multi-chip assembly 100.

In some embodiments, the multi-chip assembly 100 facilitates straightforward alignment and packaging. Users can achieve alignment simply by using tweezers, making it easy to align visually. Once the photonic chips 102 are stacked together, they automatically align without requiring precise adjustments, streamlining the assembly process. Due to the precise alignment capabilities and minimal signal loss of the modules, users can effortlessly customize their chip structure. This modular design allows for the selection and integration of various components, enabling seamless reconfiguration. In the event of damage or contamination in one of the photonic chips, the affected photonic chip can be easily replaced with an identical module. This capability allows for targeted repairs without the need to discard the entire sample, significantly reducing overall costs.

In some embodiments, the first and second connection interfaces 106 and 108 may be formed using laser, plasma dicing, or a traditional dicing saw. The remainder of the fabrication process may utilize standard manufacturing techniques. In some embodiments, and to enhance the bonding strength and further minimized optical loss, CO₂ lasers or other localized heat sources can be used to fuse the connection interfaces between the photonic chips 102. This permanent fusion process significantly reduces air gaps and Fresnel reflections, resulting in a stronger mechanical bond and improved optical performance.

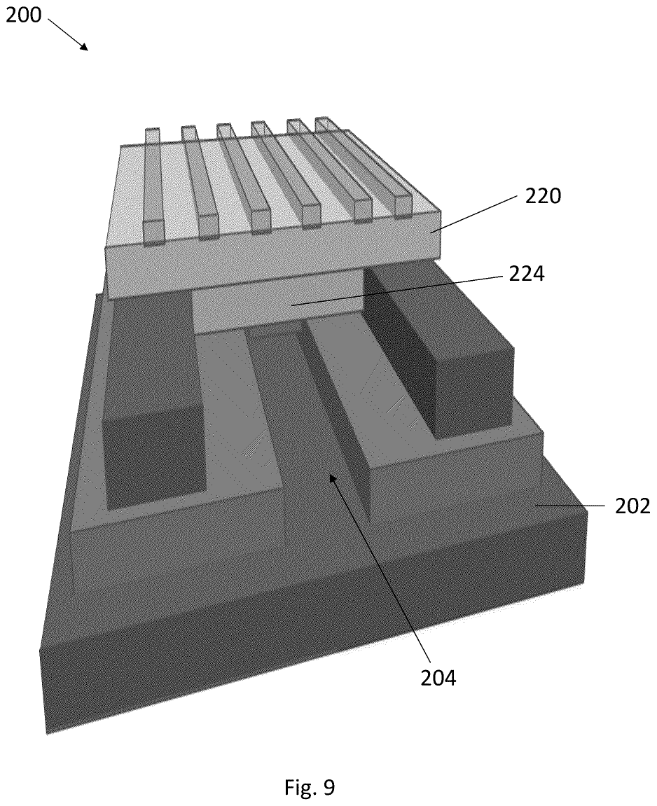

Aspects of the present disclosure relate to a modular photonic chip packaging system. The disclosed packaging system provides a novel packaging architecture for integrated photonics, enabling chip-to-chip optical connections in a compact and modular manner. Referring now to FIG. 9, a modular photonic chip packaging system 200 is shown. The system 200 generally includes a substrate 202 having at least one elongated channel 204 and a photonic chip 220 positioned on the substrate, the photonic chip 220 having at least one elongated protrusion 224 on a bottom surface, wherein the at least one protrusion is shaped to fit within the at least one elongated channel 204.

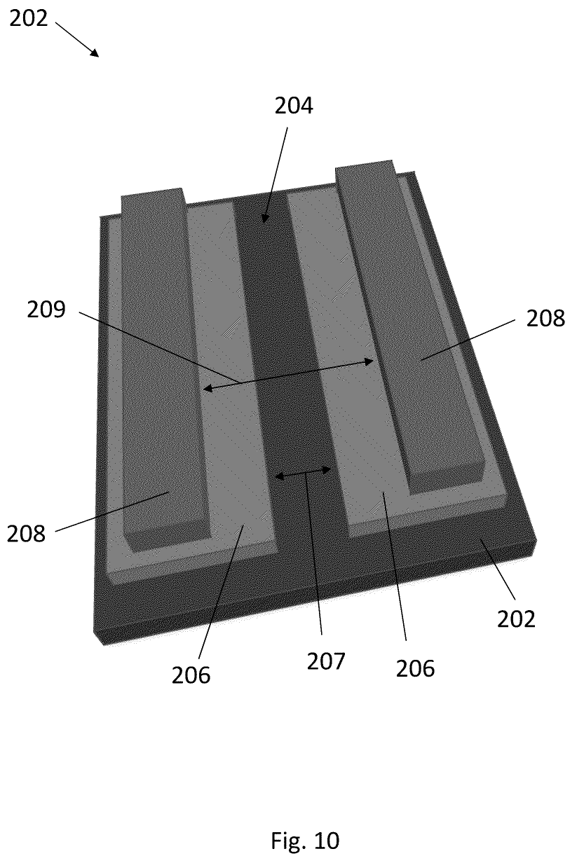

Referring now to FIG. 10, an exemplary substrate 202 is shown. The substate 202 comprises at least one elongated channel 204 extending for a length across a longitudinal axis of the substrate 200. In some embodiments, the substrate 200 may comprise materials including, but not limited to, silicon dioxide, silicon nitride, silicon oxynitride, germanium, silicon germanium, lithium niobate, aluminum nitride, barium titanate, strontium titanate, aluminum gallium arsenide, gallium nitride, indium arsenide, sapphire, diamond, or any combinations thereof.

The elongated channel 204 may comprise internal walls (for example, wall portions 206 and 208) extending upwards from the substrate 202, defining a height of the elongated channel 204. In some embodiments, the internal walls may be formed by adding additional layers to the substrate 202. The elongated channel 204 may have a non-uniformed cross-sectional geometry. For example, at a bottom channel portion the interior walls 206 may define a first width 207, and at a top channel portion the interior walls 208 may define a second width 209. The first and second widths 207 and 209 may be tapered or may be stepped. In some embodiments, the second width 209 is greater than the first width 207. In some embodiments, the second width 209 is less than the first width 207. In some embodiments, the elongated channel 204 may have a height ranging between 100 nm and 1 nm. In some embodiments, the elongated channel 204 may have any length. For example, the elongated channel 204 may have a length extending for at least a portion of the length of the substrate 202. In some embodiments, the cross-section of the elongated channel 204 may have any shape. In some embodiments, the substrate 202 may comprise a plurality of elongated channels 204, wherein the elongated channels are positioned adjacent to each other, or in a staggered manner, or in any desired orientation.

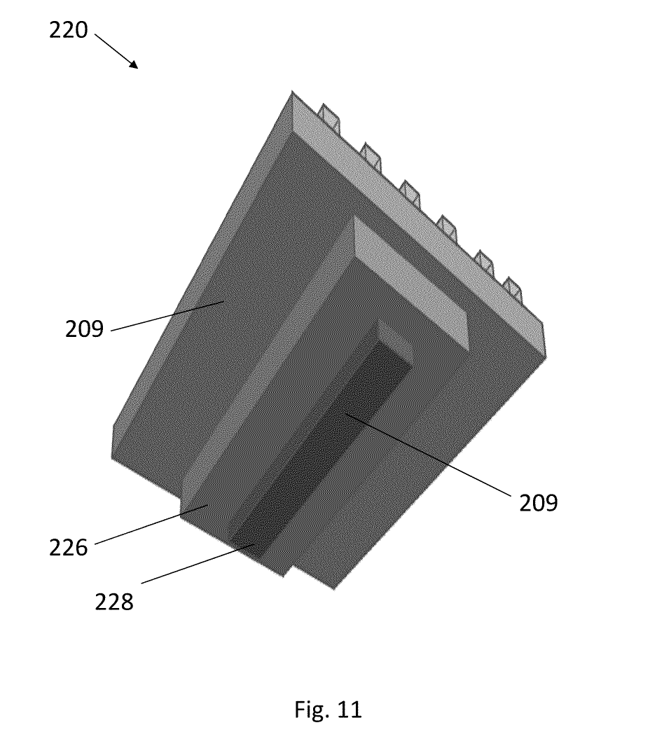

Referring now to FIG. 11, an exemplary photonic chip 220 is shown. The photonic chip 220 comprises a bottom surface 222 and an elongated protrusion 224 fixedly attached to the bottom surface 222 and shaped to fit within the elongated channel 204 of the substrate 202. In some embodiments, the protrusion 224 may have varying width across its height configured to fit within a stepped geometry of the elongated channel 202. For example, the protrusion 224 may comprise a first portion 226 having a width about equal to the width of the top channel portion and a second portion 228 having a width about equal to the width of the bottom channel portion. In some embodiments, the protrusion 224 may have any cross-sectional shape complementary to the cross-sectional shape of the elongated channel 204.

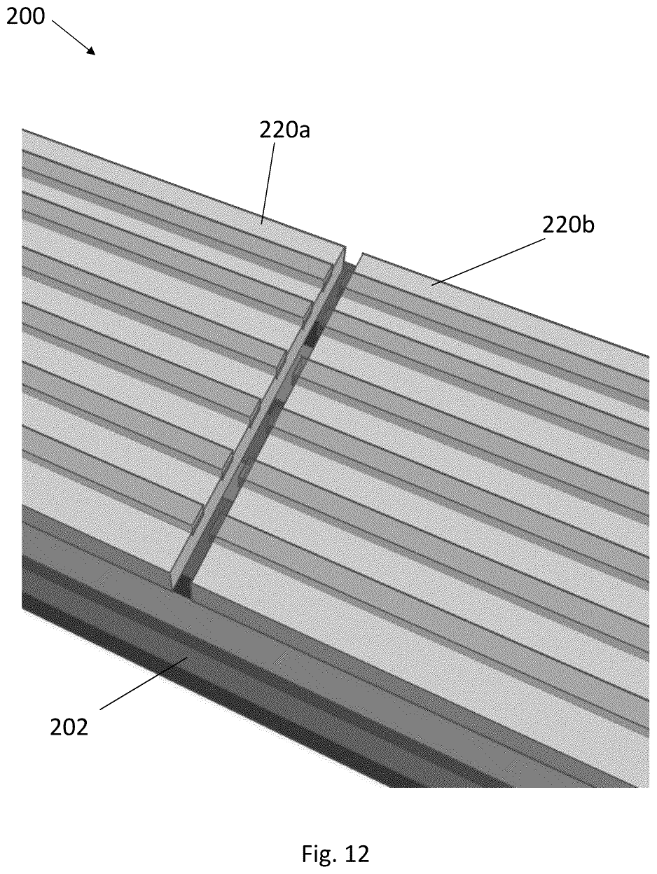

Referring back to FIG. 10, the photonic chip 220 is configured to slide into the elongated channel 204 of the substrate 202, the elongated channel 204 acting as an alignment guide for the positioning of the photonic chip 220. The substrate 202 may further comprise a notch or stop at one end of the elongated channel 204 to prevent the photonic chip from sliding beyond the desired position. In some embodiments, and referring now to FIG. 12, at least two photonic chips 220a and 220b may be optically connected by sliding the photonic chips 220a and 220b along the elongated channel 204 in an end-to-end configuration such that the first and second photonic chips 220a and 220b are optically coupled. In some embodiments, a plurality of photonic chips 220 can slide onto the substrate 202 so that the protrusion 224 aligns with the at least one elongated channel 204, ensuring accurate positioning and coupling between the chips 220, allowing the plurality of photonic chips 220 to be added or replaced as needed along the elongated channel 204 and supporting scalable system integration. The substate and chip notching facilitate self-alignment for the optical paths, minimizing insertion loss and simplifying assembly, thus overcoming the complexity and alignment issues of existing photonic packaging solutions. The system 200 enables a reliable, high-density, and easy-to-manufacture platform for multi-chip photonic integration.

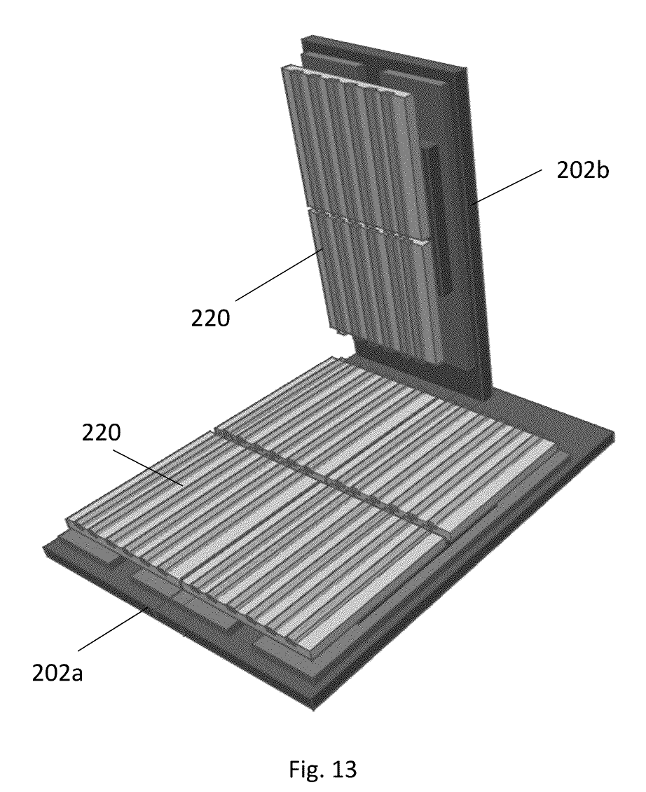

Referring now to FIG. 13, at least two substrates 202 (substates 202a and 202b) may be fixedly connected to each other. The substrates 202a and 202b may be disposed in different orientations. For example, a first substrate 202a may be oriented horizontally and a second substrate 202b may be oriented vertically. Each substrate may comprise one or more photonic chips 220 arranged along the elongated channel 204, which may also be oriented vertically or horizontally.

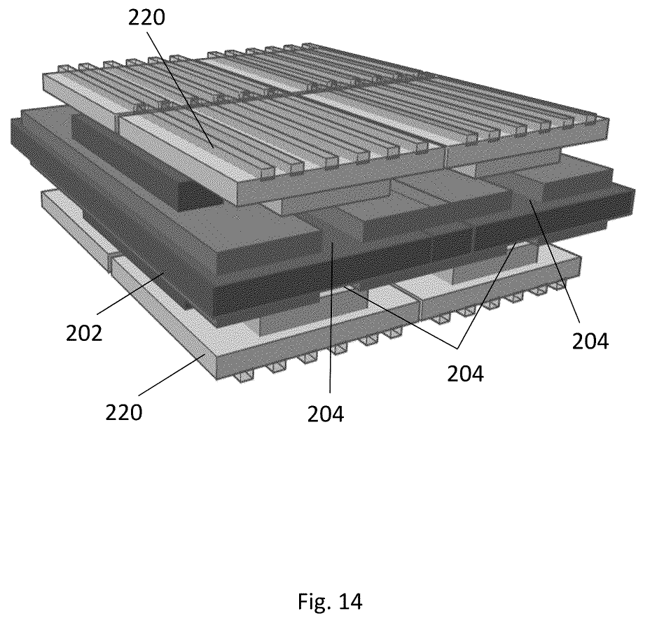

Referring now to FIG. 14, a substrate 202 may comprise at least one elongated channel 204 positioned on a top surface and at least one elongated channel 204 positioned on a bottom surface of the substrate. In this configuration, one or more photonic chips 220 may be arranged along each elongated channel 204 on opposing sides of the substrate 202 in a stacked configuration.

The packaging system 200 significantly enhances loss reduction by leveraging precise mechanical alignment and close-proximity chip placement. By sliding photonic chips into position along the channel in the substrate, the packaging system 200 minimizes the physical gap between adjacent photonic chips and their respective waveguides. The self-aligning elongated channels 204 and corresponding protrusions 224 on the photonic chip 220 ensure that the optical paths are maintained with sub-micron accuracy, thereby maximizing mode overlap and reducing free-space propagation losses at the chip interfaces. The tight, repeatable alignment directly translates to reduced insertion loss compared to conventional connection methods, such as fiber or free-space coupling, which are more susceptible to misalignment and mode mismatch. As a result, the system 200 enables robust, low-loss optical coupling for multi-chip photonic systems, supporting high-performance integration and scalable assembly without the need for bulky fixtures or active alignment procedures.

The packaging system 200 enables a straightforward and accessible alignment process that does not require specialized equipment or advanced technical skills. Proper alignment can be achieved by sliding the chips into place using a standard laboratory tweezer by hand. The mechanical self-guiding features automatically position the photonic chips with high accuracy, ensuring reliable optical path alignment between the waveguides. This hands-on, tool-free assembly greatly reduces setup time, lowers assembly costs, and facilitates rapid prototyping and scalable manufacturing of multi-chip photonic systems.

The flexible design of the packaging system 200 also supports reconfigurable and three-dimensional (3D) photonic architectures. This 3D capability enables complex, high-density integration schemes that can be easily reconfigured by adding, removing, or rearranging chips in any layer. The modular nature of the design allows for dynamic adaptation of the photonic system's functionality and scaling, providing significant advantages for prototyping, upgrading, or repairing advanced multi-chip photonic assemblies. If a module becomes damaged or contaminated, it can be quickly replaced with an identical unit without dismantling the entire assembly. This targeted repair approach reduces waste and significantly lowers overall maintenance costs.

In some embodiments, the substrate 202 and photonic chip 220 may be fabricated via lithography or etching. In some embodiments, the substrate 202 and photonic chop 220 is fabricated by depositing SiO₂ on a silicon wafer followed by standard lithography and etching processes. This approach utilizes well-established semiconductor manufacturing techniques, allowing for precise, scalable, and cost-effective production.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled, or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

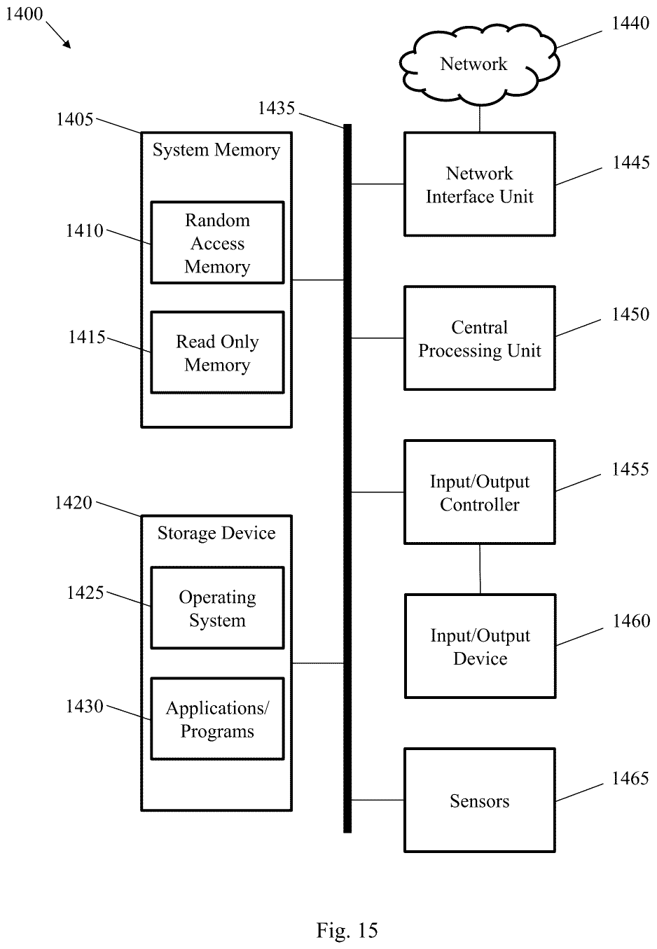

FIG. 15 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including handheld devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 15 depicts an illustrative computer architecture for a computer 1400 for practicing the various embodiments of the invention. The computer architecture shown in FIG. 15 illustrates a conventional personal computer, including a central processing unit 1450 (“CPU”), a system memory 1405, including a random access memory 1410 (“RAM”) and a read-only memory (“ROM”) 1415, and a system bus 1435 that couples the system memory 1405 to the CPU 1450. A basic input/output system containing the basic routines that help to transfer information between elements within the computer, such as during startup, is stored in the ROM 1415. The computer 1400 further includes a storage device 1420 for storing an operating system 1425, application/program 1430, and data.

The storage device 1420 is connected to the CPU 1450 through a storage controller (not shown) connected to the bus 1435. The storage device 1420 and its associated computer-readable media provide non-volatile storage for the computer 1400. Although the description of computer-readable media contained herein refers to a storage device, such as a hard disk or CD-ROM drive, it should be appreciated by those skilled in the art that computer-readable media can be any available media that can be accessed by the computer 1400.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 1400 may operate in a networked environment using logical connections to remote computers through a network 1440, such as TCP/IP network such as the Internet or an intranet. The computer 1400 may connect to the network 1440 through a network interface unit 1445 connected to the bus 1435. It should be appreciated that the network interface unit 1445 may also be utilized to connect to other types of networks and remote computer systems.

The computer 1400 may also include an input/output controller 1455 for receiving and processing input from a number of input/output devices 1460, including a keyboard, a mouse, a touchscreen, a camera, a microphone, a controller, a joystick, or other type of input device. Similarly, the input/output controller 1455 may provide output to a display screen, a printer, a speaker, or other type of output device. The computer 1400 can connect to the input/output device 1460 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 1420 and/or RAM 1410 of the computer 1400, including an operating system 1425 suitable for controlling the operation of a networked computer. The storage device 1420 and RAM 1410 may also store one or more applications/programs 1430. In particular, the storage device 1420 and RAM 1410 may store an application/program 1430 for providing a variety of functionalities to a user. For instance, the application/program 1430 may comprise many types of programs such as a word processing application, a spreadsheet application, a desktop publishing application, a database application, a gaming application, internet browsing application, electronic mail application, messaging application, and the like. According to an embodiment of the present invention, the application/program 1430 comprises a multiple functionality software application for providing word processing functionality, slide presentation functionality, spreadsheet functionality, database functionality and the like.

The computer 1400 in some embodiments can include a variety of sensors 1465 for monitoring the environment surrounding and the environment internal to the computer 1400. These sensors 1465 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A multi-chip assembly, comprising:
a first and a second photonic chip, each photonic chip comprising:
one or more layers forming a body having at least a first side and a second side;
wherein the first side comprises a first connection interface comprising at least one protrusion and the second side comprises a second connection interface comprising at least one divot; and
wherein the first and second connection interfaces of the first and second photonic chips respectively, are configured to couple in an interlocking manner.

2. The multi-chip assembly of claim 1, wherein the at least one protrusion and the at least one divot have complementary geometries.

3. The multi-chip assembly of claim 1, wherein the at least one protrusion and the at least one divot have a square shape, a rectangular shape, a circular shape, an ovular shape, an arc shape, an irregular shape, or any combinations thereof.

4. The multi-chip assembly of claim 1, wherein the at least one protrusion and the at least one divot are formed in at least one layer of the one or more layers.

5. The multi-chip assembly of claim 1, wherein the first side and the second side are opposing sides.

6. The multi-chip assembly of claim 1, wherein the first side and the second side are adjacent sides.

7. The multi-chip assembly of claim 1, wherein the one or more layers comprise a top layer, a middle layer, and a bottom layer.

8. The multi-chip assembly of claim 7, wherein the one or more layers comprise a material selected from the group consisting of: silicon dioxide, silicon nitride, silicon oxynitride, germanium, silicon germanium, lithium niobate, aluminum nitride, barium titanate, strontium titanate, aluminum gallium arsenide, gallium nitride, indium arsenide, sapphire, and diamond.

9. The multi-chip assembly of claim 1, wherein the first photonic chip and the second photonic chip are oriented perpendicularly to each other.

10. The multi-chip assembly of claim 1, wherein the first and second photonic chips further comprise a waveguide integrated into at least one layer of the one or more layers and extending between the first and second connection interfaces of each photonic chip, wherein the coupling of the first and second connection interfaces of the first and second photonic chips causes the waveguides to be optically aligned.

11. A modular photonic chip packaging system, comprising:
a substrate having at least one elongated channel;
at least one photonic chip positioned on the substrate, the at least one photonic chip having a bottom surface and at least one elongated protrusion on the bottom surface,
wherein the at least one elongated protrusion is shaped to fit within the at least one elongated channel.

12. The photonic chip packaging system of claim 11, wherein the at least one elongated channel comprises a bottom channel portion having a first width and a top channel portion having a second width.

13. The photonic chip packaging system of claim 11, wherein the at least one elongated protrusion comprises a first portion having a width equal to the first width of the elongated channel and a second portion having a width equal to the second width of the elongated channel.

14. The photonic chip packaging system of claim 11, further comprising at least two photonic chips arranged along the elongated channel, such that the at least two photonic chips are optically coupled.

15. The photonic chip packaging system of claim 11, further comprising a plurality of photonic chips arranged along the elongated channel, such that the plurality of photonic chips are optically coupled.

16. The photonic chip packaging system of claim 11, further comprising a plurality of elongated channels, and a plurality of photonic chips arranged along each channel, such that the plurality of photonic chips along each channel are optically coupled.

17. The photonic chip packaging system of claim 11, wherein the substrate comprises a top surface and a bottom surface, wherein the top surface and the bottom surface each comprise at least one elongated channel.

18. The photonic chip packaging system of claim 17, wherein a plurality of photonic chips are positioned along each elongated channel on the top and bottom surfaces of the substrate.

19. The photonic chip packaging system of claim 11, further comprising a first substrate and a second substrate fixedly attached to each other.

20. The photonic chip packaging system of claim 19, wherein the first and second substrates are oriented perpendicularly to each other.
